(19) United States
(12) Patent Application Publication
(10) Pub. No.: US 2015/0184806 A1
(43) Pub. Date: Jul. 2, 2015

(54) APPARATUS AND METHOD FOR REDUCING THE EFFECT OF JOULE-THOMSON COOLING

(71) Applicant: Caltec Limited, Bedfordshire (GB)

(72) Inventors: Mirza Najam Ali Beg, Milton Keynes (GB); Mir Mahmood Sarshar, Buckinghamshire (GB)

(21) Appl. No.: 14/412,333

(22) PCT Filed: Jun. 26, 2013
(86) PCT No.: PCT/GB2013/051689

§ 371 Date: Dec. 31, 2014

(30) Foreign Application Priority Data
Jul. 3, 2012 (GB) 1211767.7

(51) Int. Cl. F17D 1/20; F15D 1/02

(52) U.S. Cl. CPC F17D 1/20; F15D 1/025

(57) ABSTRACT

The apparatus consists of modular stages arranged in series, each stage including a main chamber and a nozzle opening. In practice, a fluid passing through the opening is subject to a pressure drop as it enters a main chamber of a subsequent stage in the series. This multi-stage pressure drop avoids a sharp drop in temperature, as would occur if the total pressure drop was achieved in one stage, that may cause hydrates to form in an oil/gas pipeline.

### CROSS-REFERENCE TO RELATED APPLICATIONS

This application is the U.S. national phase of PCT international application number PCT/GB2013/051689 filed Jun. 26, 2013, which claims priority to United Kingdom application GB 1211767.7 filed Jul. 3, 2012, the disclosures and benefits of which are incorporated in their entireties by reference herein.

### TECHNICAL FIELD

The present invention relates to an apparatus for minimising the effect of Joule-Thomson cooling, especially in the oil and gas extraction industry.

### BACKGROUND TO THE INVENTION

The Joule-Thomson effect is a well known thermodynamic phenomenon related to the drop in the temperature of any gas as its pressure drops and its volume expands: the bigger the drop in pressure of the gas, the bigger the drop in temperature of gas. This property has been used successfully in applications such as refrigeration. It is also well known in the oil and gas industry that if water is present with produced gas, a physical bonding takes place between the molecules of water and light hydrocarbon gas molecules, such as ethane, methane and propane at a particular pressure and temperature. This physical bonding forms snow like particles known as hydrates which, when formed, accumulate at various points along their flow path or at points which have a restriction such as valves or flanged connecting points. The accumulation of hydrates can potentially block the passage of fluids completely.

The formation of hydrates is dependent on the combined temperature and pressure of the system. At higher pressures, hydrates form at higher temperatures, compared to low pressure cases when hydrates may form at a much lower temperature. In such cases hydrate inhibitors such as methanol or MEG (Glycol) are injected to change the temperature at which hydrates can form. This is analogous to adding anti-freeze to the cooling water of a vehicle radiator to prevent water turning into ice at sub-zero temperatures during winter.

In the oil and gas industry when a producing well is shut in for some time, the shut-in wellhead pressure increases significantly. At the time the operator re-opens the well, a sudden drop in the pressure of gas across the choke valve or the wing valve of the well may cause a Joule-Thomson cooling effect. The significant drop in the temperature of produced hydrocarbons could lead to formation of hydrates. There are also safety cases where the produced gas is released to atmosphere or a flare system, and in such cases the low temperatures generated could lead to hydrates forming within the blow down system. Operators are therefore keen to have a system which prevents low temperatures being generated during the blow down or opening of the wells without having to inject vast quantities of hydrate suppressants.

### BRIEF DESCRIPTION OF THE DRAWINGS

FIG. 1 illustrates a side section view according to the invention;

FIG. 2 illustrates a side section view according to the invention;

FIG. 3 illustrates a side section view according to the invention;

FIG. 4 illustrates an end and side section view according to the invention; and

FIG. 5 illustrates a schematic view of an oil production line incorporating an apparatus of the invention.

### DETAILED DESCRIPTION OF THE INVENTION

The present invention seeks to provide a system which minimises the Joule-Thomson effect or the level by which the temperature of the mixture may drop as the pressure of gas drops across a valve, and thus prevents formation of hydrates in such cases.

In a broad aspect of the invention there is provided an apparatus for minimising the effect of Joule-Thomson cooling, comprised of a plurality of stages arranged in series, each stage including a main chamber and an opening where, in use, a fluid passing through the main chamber is subject to a pressure drop as it exits the opening into a main chamber of a subsequent stage in the series.

Preferably the pressure drop between stages generates sonic flow through the opening of each stage. Preferably the pressure drops by a factor of approximately 1.5 to 2.5, most preferably 1.8-2.0.

Preferably the opening is incorporated in a nozzle. The diameter of the opening may be varied between stages or be adjustable to match the expected flow rate of gas at the operating pressure and temperature and to create the pressure ratio between each stage.

Preferably the main chamber is in the form of a cylindrical bore or pipe section. In one form of the invention the opening is provided in a disc section that abuts the pipe section such that, in practice, a plurality of alternating pipe sections and disc sections can be stacked in series to build the apparatus.

The stages may also be modular components, each including a main chamber and opening, that fit together to provide the series of stages communicating there between via the opening(s).

It will be apparent that the apparatus or system for implementation in an oil or gas line to reduce the effect of Joule-Thomson cooling according to the invention consists of a number of similar components which help to drop the pressure of gas at several stages. At each stage, the pressure may drop by a factor close to two in order to maintain a sonic velocity across the nozzle of each stage. The total pressure drop ratio across the total system (multiple stages) can be high and may vary from typically 4 to 1, to as high as 70 to 1 or higher. The number of the stages can therefore vary depending on the ratio of the high pressure gas to that of the downstream gas pressure. So, if the high pressure to downstream pressure ratio is 16, the system staged pressure drop will be from 16 to 8, 8 to 4, 4 to 2 and finally 2 to 1.

An approximate 2 to 1 pressure ratio between each stage does not need to be exactly 2 and in some cases it could be higher depending on the composition of gas, the original temperature and high pressure to discharge pressure ratio. A pressure drop ratio of 1.8 to 1 has proven to generate sonic flow through the nozzle of each stage.

As previously mentioned, the present invention involves the provision of a series of pressure reducing stages 3 in a production line. In order to simplify and standardise the system each component of the system would preferably have similar general configurations which can be pushed inside a pipe section S in tandem/series as shown in FIG. 1.

At each stage 3, the pressure drop across the nozzle 5 of the section can allow the pressure to drop by, say, a factor of two, to generate sonic flow. The flow after passing through a nozzle opening 5 of the first unit A then passes through a short chamber (the length of the opening 5) within which a shock wave may be generated. The flow then enters a main chamber 2 of second unit B and within the length of the second unit/chamber; it expands, reducing its velocity.

This process is repeated as the flow passes through each unit A to D (and further units if necessary). It is believed that by dropping the pressure of gas in several stages in the manner described according to the invention, the final and total temperature drop across the system would be much less than that predicted if the pressure of gas dropped through a single stage, which would occur in cases where there is a pressure drops across a choke valve or a control valve.

The proposed multi-stage system does not prevent a drop in the temperature of gas but will reduce the J-T effect and will limit the temperature drop to a value which is outside the hydrate formation band at the given pressure.

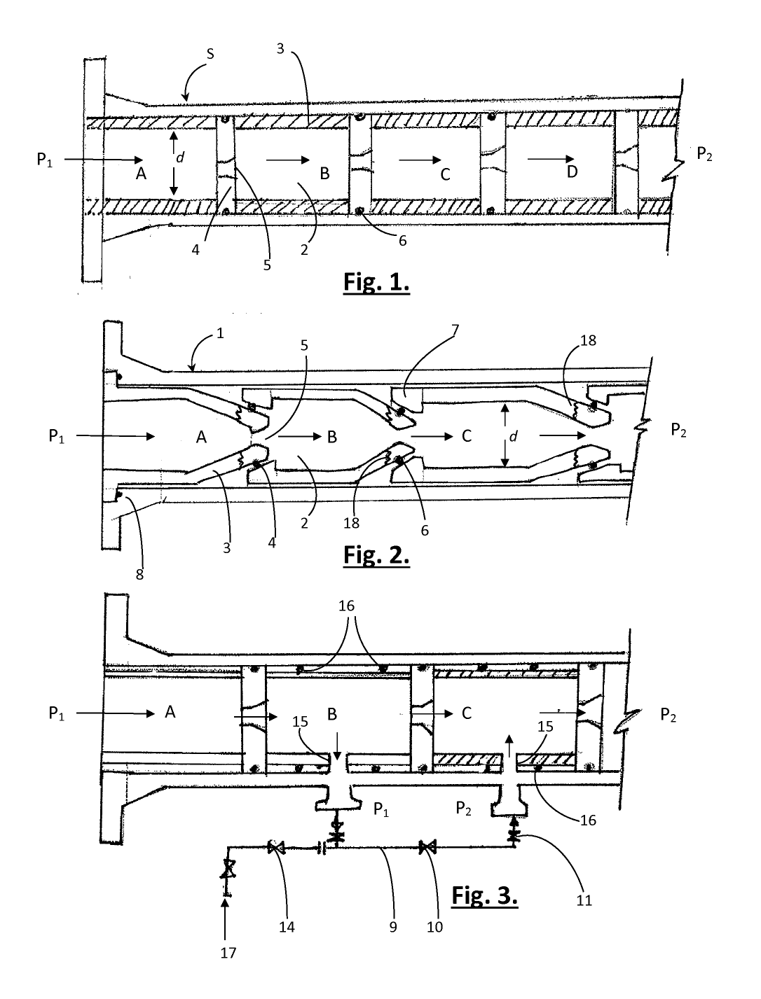

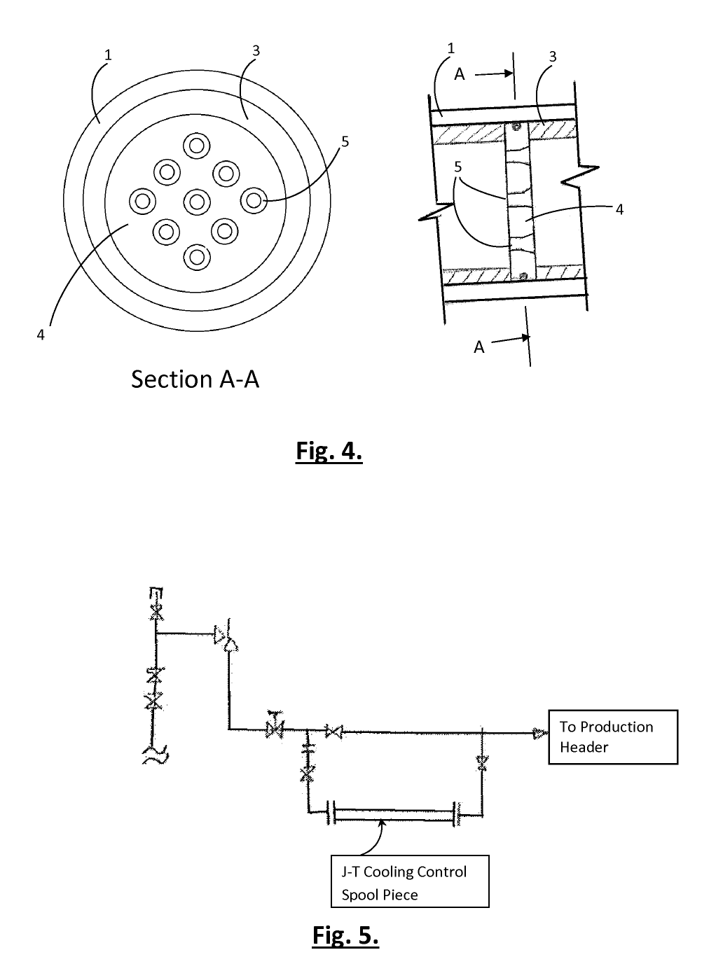

Features of the apparatus with reference to the Figures are as follows:
A cylindrical body 3 which has a known diameter and a length preferably equal to at least twice the internal diameter.
A nozzle 5 at the downstream end of the first unit A to cause the first pressure drop stage. This nozzle may be part of a disc shaped section 4 as shown in FIG. 1. Alternatively, it may be part of the body of a section 3 tapered to form the end nozzle, as shown in FIG. 2.
Each unit is preferably isolated by seal ring 6 so that there is no escape of gas or pressure from one unit to the next unit by routes other than the nozzle of each unit.
FIG. 2 shows a variation in the configuration of each single unit section 3 by having a receiving end 7 to allow the seal between two consecutive units to be effective.
The number of units within each system is dependent on the ratio of the pressure at the inlet and the outlet of the system as desired or dictated by the operating conditions of the downstream pipeline or process system.
A control valve or an adjustable choke valve may be included downstream of the system to provide added flexibility for the last stage of system and final pressure drop, or for tuning the system.
The nozzle or orifice 5 for each unit may have a different dimension so that it allows the same mass of gas to pass through at the prevailing pressure and temperature. In order to make each unit as similar as possible for ease of fabrication the section carrying the nozzle may be a separate disc as in FIG. 1, or the nozzle end can be a separate machined part screwed to the end of the unit through threaded joint 18, as shown in FIG. 2.
As a variation to the system and to achieve a better performance, meaning less temperature drop across the system for the same level of pressure drop, each or selected unit stages can be fed gas from a previous stage via pipe work 9 and inlet and outlet P₁ and P₂ as shown in FIG. 3. A valve 10 allows the pressure from a previous stage to drop to that of the next stage and also to regulate the flow through parallel line 9. Valves 11 and 12 enable individual control of inlets to respective stages C and B.
Alternatively, or in addition, gas or liquids from a separate source can be introduced into each unit via line 17 and valve 14 as shown in FIG. 3. As also shown in FIG. 3, seals 16 enable the isolation of each section and flow of gas through port holes 15. The impact of introducing gas or liquids from a source to each stage is to help with further recovery of temperature or to minimise temperature loss through each unit.
The end result when such a system is used is that the pressure P₁ from the inlet point can drop significantly to its outlet point P₂, but the temperature loss across the system will be significantly less than that achieved by dropping the pressure across a valve or a choke valve. By doing so, as the temperature of the gas will not drop significantly, the outlet temperature will be above the hydrate formation range and thus there will be no need to introduce hydrate inhibitors such as methanol.
As a further extension of the illustrated systems shown in FIGS. 1 to 3, according to FIG. 4 the disc 4 which carries the nozzle 5 may contain more than one nozzle. The multi-nozzle assembly shown in FIG. 4 helps to split the flow into a number of smaller nozzles which also has the benefit of modifying the design for different applications where the flow rate of gas will be different. In such cases some of the nozzles can be blocked off to match the relevant flow rate of gas.

FIG. 5 shows the general arrangement of the system at a wellhead which allows the J-T cooling control spool piece of the invention to be brought into the stream during start up of the well or to bypass it during the normal mode of production.

Components of the present invention can be manufactured from available materials, tools and techniques. It will be apparent that while the illustrated embodiment of FIG. 2 features a conical end with an outlet nozzle, an equivalent apparatus comprised of modular component according to the invention could alternatively be made with a restricted inlet opening that communicates with a wider outlet of a preceding modular component.

1. An apparatus for installation in a pipeline to minimise the effect of Joule-Thomson cooling, comprising a plurality of stages arranged in series, each stage including a main chamber and an opening wherein, in use, a fluid passing through the opening is subject to a pressure drop as it enters a main chamber of a subsequent stage in the series.

2. The apparatus of claim 1 wherein the pressure drop between stages generates sonic flow through the opening.

3. The apparatus of claim 1 wherein the length of a main chamber is at least twice its internal diameter.

4. The apparatus of claim 1 wherein the cross sectional area of subsequent openings varies across the plurality of stages or is adjustable.

5. The apparatus of claim 1 wherein the opening is a nozzle.

6. The apparatus of claim 1 wherein the opening is formed in a disc or plate abutting or located across a pipe section.

7. The apparatus of claim 1 wherein there are multiple openings.

8. The apparatus of claim 1 wherein the pressure drops between stages by a factor of approximately 1.5 to 2.5, most preferably 1.8-2.0.

9. The apparatus of claim 1 wherein the main chamber is in the form of a cylindrical bore or pipe section.

10. The apparatus of claim 1 wherein the stages are a plurality of modular components, each including a main chamber and opening, that fit together to provide the series of stages communicating there-between via the opening(s).

11. The apparatus of claim 10 wherein at least one of the modular components includes a tapered or conical end toward the opening.

12. The apparatus of claim 11 wherein the modular component includes a receiving end to receive a tapered or conical end of an adjacent component.

13. The apparatus of claim 1 including gaskets or appropriate seals to prevent unwanted leaking of fluid between stages or around the pipeline.

14. A modular component for use in an apparatus to minimise the effect of Joule-Thomson cooling according to claim 1, including a chamber with an opening end including a tapered or conical portion and a receiving end for receiving the opening end of another modular component.

15. A method of minimising the effect of Joule-Thomson cooling in a pipeline, wherein a plurality of stages arranged in series are provided in the pipeline, each stage including a main bore or pipe section and an opening at a downstream end of the bore/pipe section wherein, in use, a fluid passing through the opening is subject to a pressure drop as it enters the bore/pipe section of a subsequent stage in the series.

16. The method of claim 15 wherein the opening is provided in a plate or disc arranged abutting and/or across the bore/pipe section.

17. The method of claim 16 wherein there is a plurality of openings in the plate or disc and/or the size of the opening(s) is varied between subsequent stages.

18. The method of claim 15 wherein the pressure drop ratio between stages is approximately 1.5 to 2.5.

19. The method of claim 18 wherein the pressure drop and/or dimensions of bore/openings of stages is selected to achieve sonic flow.

20. The method of claim 15 wherein a plurality of alternating pipe sections and plate/disc sections is stacked in series to build an apparatus.
